(19) United States
(12) Patent Application Publication
(10) Pub. No.: US 2022/0241959 A1
(43) Pub. Date: Aug. 4, 2022

(54) MODULE ROBOT

(71) Applicants: KYB-YS CO., LTD., Nagano (JP); The Ritsumeikan Trust, Kyoto-shi, Kyoto (JP)

(72) Inventors: Shunichi SUGIMOTO, Toyota-shi, Aichi (JP); Sang-Ho HYON, Minami-ku, Kyoto (JP); Yasushi SAITOU, Nagano (JP); Sadayuki KAMIKURA, Nagano (JP); Nobuyuki KOBAYASHI, Nagano (JP); Shinichi NISHIZAWA, Ueda-shi, Nagano-ken (JP); Setsuko UCHIDA, Ueda-shi, Nagano (JP)

(73) Assignees: KYB-YS CO., LTD., Nagano (JP); The Ritsumeikan Trust, Kyoto-shi, Kyoto (JP)

(21) Appl. No.: 17/622,903

(22) PCT Filed: Jun. 29, 2020
(86) PCT No.: PCT/JP2020/025562

§ 371 Date: Dec. 27, 2021

(30) Foreign Application Priority Data
Jun. 27, 2019 (JP) 2019-119950

(51) Int. Cl. B25J 9/08; F15B 13/02

(52) U.S. Cl. CPC B25J 9/08; F15B 13/02

(57) ABSTRACT

A module robot 100 is configured by coupling a plurality of modules 101, the modules 101 each having a first link 1, a second link 2 movably linked to the first link 1 relatively, and a hydraulic cylinder 3 configured to move the first link 1 and the second link 2 relatively.

### TECHNICAL FIELD

The present invention relates to a module robot.

### BACKGROUND ART

In recent years, a wide variety of robots, such as industrial robots, transport robots, assistance robots, and so forth, have been developed. JP2018-192607A discloses an industrial robot performing replacement work of cables. JP2017-40594A discloses a transport robot carrying packages. JP2018-153542A discloses a gait assistance robot assisting gait exercise of a user.

### SUMMARY OF INVENTION

In general, like the robots described in above patent Literatures, robots are respectively manufactured for specific applications and cannot be diverted into other applications.

In addition, the robot specialized for specific applications may have a structure that is too complicated to be assembled, and in addition, the robot may be bulky so that its transportation is difficult.

An object of the present invention is to provide a module robot capable of adapting a wide variety of applications and capable of being assembled and transported with ease.

According to one aspect of the present invention, a module robot is configured by coupling a plurality of modules, the modules each having a first member, a second member movably linked to the first member relatively, and a fluid pressure cylinder configured to move the first member and the second member relatively.

### BRIEF DESCRIPTION OF DRAWINGS

FIG. 1 is a perspective view of a module of a module robot according to a first embodiment of the present invention.

FIG. 2 is a system configuration diagram of the module robot.

FIG. 3 is a diagram showing a coupling example of the modules.

FIG. 4 is a diagram showing the coupling example of the modules.

FIG. 5 is a diagram showing the coupling example of the modules.

FIG. 6 is a side view of the module robot forming a leg portion by coupling the modules.

FIG. 7 is a sectional view showing a modification of the first embodiment of the present invention.

FIG. 8 is a schematic view of a module according to a second embodiment of the present invention.

### DESCRIPTION OF EMBODIMENTS

Embodiments of the present invention will be described below with reference to the drawings.

### First Embodiment

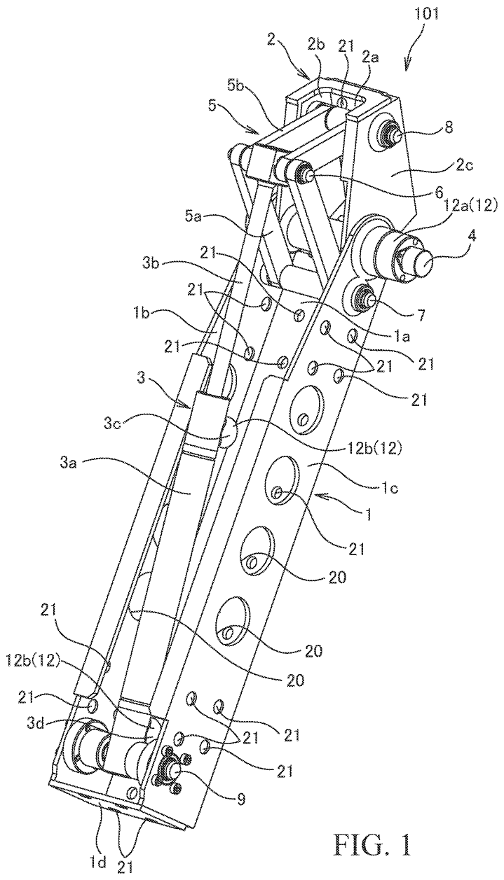

A module robot 100 according to a first embodiment of the present invention will be described first with reference to FIGS. 1 to 6.

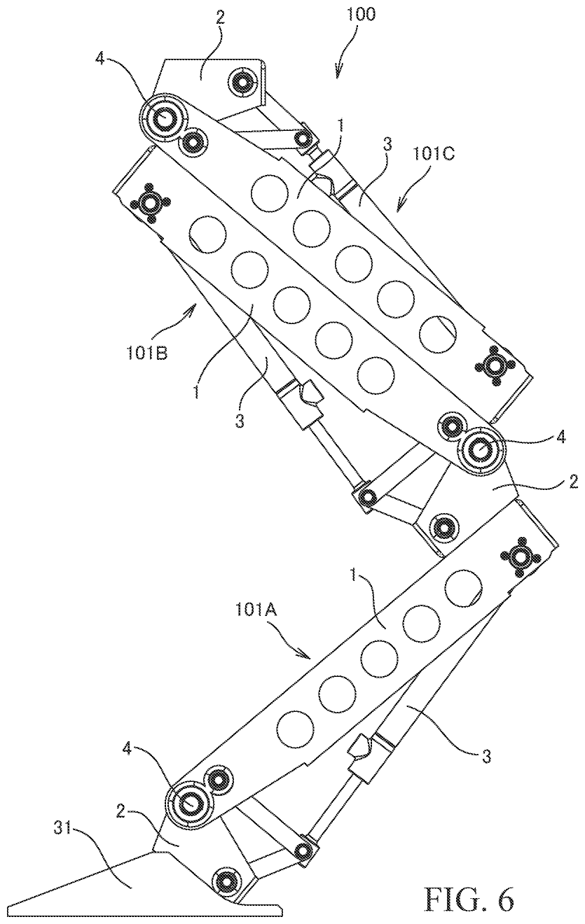

The module robot 100 (see FIG. 6) is configured by coupling a plurality of modules 101 shown in FIG. 1.

The module 101 will be described first with reference to FIG. 1. FIG. 1 is a perspective view of the module 101.

The module 101 has a first link 1 serving as a first member, a second link 2 serving as a second member that is movably linked to the first link 1 relatively, and a hydraulic cylinder 3 serving as a fluid pressure cylinder that moves the first link 1 and the second link 2 relatively with each other.

The first link 1 and the second link 2 are rotatably linked via a shaft 4 each other. The module 101 further has a V-shaped link 5 serving as a third link that rotatably links the first link 1 and the second link 2. The V-shaped link 5 has a first lever 5a and a second lever 5b that are rotatably linked via a shaft 6 each other. The first lever 5a is rotatably linked to the first link 1 via a shaft 7, and the second lever 5b is rotatably linked to the second link 2 via a shaft 8.

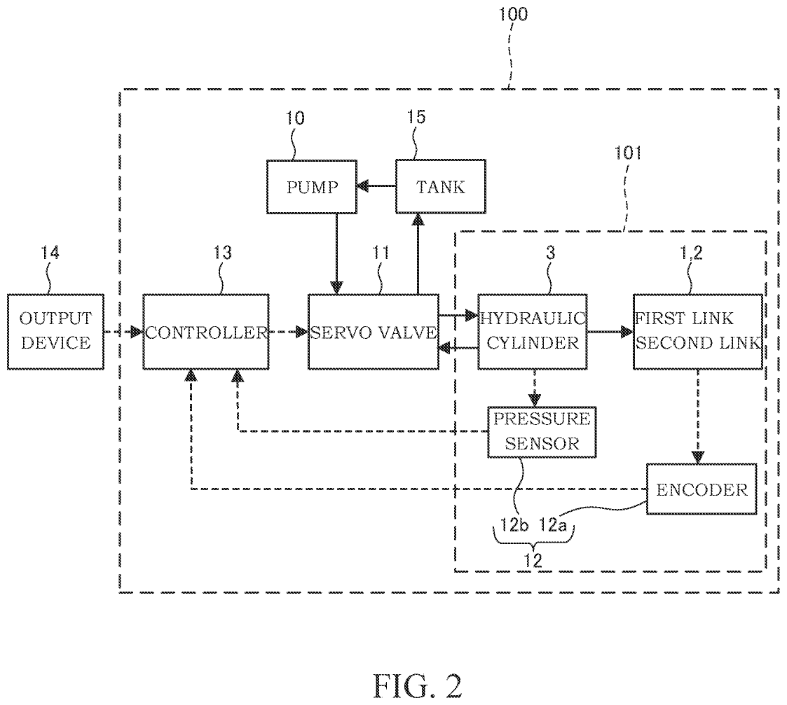

The hydraulic cylinder 3 is an actuator that is extended/contracted by working oil (working fluid) supplied from a pump 10 serving as a working fluid source (see FIG. 2). The hydraulic cylinder 3 has a cylinder tube 3a having a cylindrical shape and a piston rod 3b that is freely slidably inserted into the cylinder tube 3a. An end portion of the cylinder tube 3a is linked to the first link 1 via a shaft 9 so as to be freely rotatable, and an end portion of the piston rod 3b is linked to the shaft 6 of the V-shaped link 5 so as to be freely rotatable. Here, the end portion of the cylinder tube 3a may be linked to the shaft 6 of the V-shaped link 5 so as to be freely rotatable, and the end portion of the piston rod 3b may be linked to the first link 1 via the shaft 9 so as to be freely rotatable. As described above, in the hydraulic cylinder 3, one of the end portions is linked to the first link 1 so as to be freely rotatable.

The piston rod 3b is connected to a piston that is inserted into the cylinder tube 3a so as to be freely slidable. An interior of the cylinder tube 3a is divided into a rod side chamber and a counter rod side chamber by the piston. The cylinder tube 3a is provided with a first supply/discharge port 3c that communicates with the rod side chamber and a second supply/discharge port 3d that communicates with the counter rod side chamber.

The hydraulic cylinder 3 is contracted as the working oil is supplied from the pump 10 to the rod side chamber through the first supply/discharge port 3c and as the working oil in the counter rod side chamber is discharged to a tank 15 (see FIG. 2) through the second supply/discharge port 3d. On the other hand, the hydraulic cylinder 3 is extended as the working oil is supplied from the pump 10 to the counter rod side chamber through the second supply/discharge port 3d and as the working oil in the rod side chamber is discharged to the tank 15 through the first supply/discharge port 3c. As the hydraulic cylinder 3 is extended/contracted, an angle of the V-shaped link 5 (the angle formed by the first lever 5a and the second lever 5b) is changed, thereby causing the first link 1 and the second link 2 to rotate about the shaft 4 relatively. As described above, the first link 1 and the second link 2 can be rotated relatively with each other by driving the hydraulic cylinder 3. The module 101 has single degree of rotational freedom about the shaft 4. The first link 1, the second link 2, and the hydraulic cylinder 3 are linked such that single degree of freedom is achieved.

By adjusting a length of the V-shaped link 5 (lengths of the first lever 5a and the second lever 5b) and attachment positions of the V-shaped link 5 (the positions of the shafts 7 and 8) with respect to the first link 1 and the second link 2, relative rotational angle and relative rotational speed of the first link 1 and the second link 2 with respect to the stroke length and the stroke speed of the hydraulic cylinder 3 are respectively adjusted.

As shown in FIG. 1, because the hydraulic cylinder 3 is of a mono-tube type, the first supply/discharge port 3c and the second supply/discharge port 3d are respectively provided on both ends of the cylinder tube 3a. Instead of this configuration, the hydraulic cylinder 3 may be of a twin-tube type. In such a case, because the first supply/discharge port 3c and the second supply/discharge port 3d can be arranged collectively on one end of the cylinder tube 3a, routing of pipes (not shown) respectively connected to the first supply/discharge port 3c and the second supply/discharge port 3d becomes easier. In the above, even if the hydraulic cylinder 3 is of the mono-tube type, by forming a pair of oil passages respectively communicating with the rod side chamber and the counter rod side chamber in the piston rod 3b, it is possible to arrange the first supply/discharge port 3c and the second supply/discharge port 3d at a tip end side of the piston rod 3b collectively. In addition, even if the hydraulic cylinder 3 is of the mono-tube type, by forming the oil passage that communicates with the rod side chamber in a body portion of the cylinder tube 3a so as to extend in the longitudinal direction, it is possible to collectively arrange the first supply/discharge port 3c and the second supply/discharge port 3d on the side of the end portion of the cylinder tube 3a. In such a case, by using a three-dimensional printer for molding of the cylinder tube 3a, it is possible to easily form the oil passage that communicates with the rod side chamber in the body portion of the cylinder tube 3a.

Next, a system configuration of the module robot 100 will be described with reference to FIG. 2. FIG. 2 is a system configuration diagram of the module robot.

In addition to the module 101, the module robot 100 includes: the pump 10 that supplies the working oil to the hydraulic cylinder 3; a servo valve 11 serving as a control valve for controlling supply and discharge of the working oil between the pump 10 and the hydraulic cylinder 3; a sensor 12 serving as a state-quantity detector for detecting a state quantity of the module 101; and a controller 13 that controls motion of the module 101 by controlling operation of the servo valve 11 on the basis of the detection result from the sensor 12.

The servo valve 11 is provided for every hydraulic cylinder 3 of the respective module 101. In other words, the respective hydraulic cylinders 3 of the modules 101 are controlled independently by the servo valves 11 that are provided in a corresponding manner. By providing the servo valve 11 so as to be connected to the first link 1, the servo valve 11 may be modularized together with the first link 1, the second link 2, and the hydraulic cylinder 3. In other words, the servo valve 11 may be configured as a component of the module 101. By employing such a configuration, it is possible to reduce lengths of pipes for connecting the servo valve 11 with the first supply/discharge port 3c and the second supply/discharge port 3d of the hydraulic cylinder 3.

In this embodiment, the module 101 has: as the sensor 12, an encoder 12a that detects the relative rotational angle between the first link 1 and the second link 2 as the state quantity of the module 101; and a pressure sensor 12b that detects a pressure of the hydraulic cylinder 3 as the state quantity of the module 101. The encoder 12a and the pressure sensor 12b are each configured as a component of the module 101.

The encoder 12a is provided on the shaft 4 and detects the relative rotation between the first link 1 and the second link 2. The detection result from the encoder 12a is used for a position control of the module 101. Instead of providing the encoder 12a, a stroke sensor for detecting a stroke amount may be provided on the hydraulic cylinder 3, and the relative rotational angle between the first link 1 and the second link 2 may be computed on the basis of the stroke amount of the hydraulic cylinder 3.

The pressure sensors 12b are respectively provided on the first supply/discharge port 3c and the second supply/discharge port 3d of the cylinder tube 3a and detect the pressures in the rod side chamber and the counter rod side chamber in the cylinder tube 3a. The detection results from the pressure sensors 12b are used for a load control of the module 101. Instead of providing the pressure sensors 12b, a load sensor for detecting the load acting on the hydraulic cylinder 3 as the state quantity of the module 101 may be provided on the hydraulic cylinder 3.

The state quantity of the module 101 to be detected by the sensor 12 may include, a stroke speed of the hydraulic cylinder 3, a flow amount of the working oil to be supplied to the hydraulic cylinder 3, and so forth, in addition to the relative rotational angle between the first link 1 and the second link 2, the pressure of the hydraulic cylinder 3, and the load acting on the hydraulic cylinder 3 as described above. If the stroke speed of the hydraulic cylinder 3 is to be detected, the stroke sensor as the sensor 12 may be provided on the hydraulic cylinder 3. And if the flow amount of the working oil supplied to the hydraulic cylinder 3 is to be detected, flow amount sensors as the sensor 12 may respectively be provided on the first supply/discharge port 3c and the second supply/discharge port 3d. The state quantity of the module 101 to be detected by the sensor 12 may be selected appropriately in accordance with a motion control of the module 101.

The controller 13 computes deviation between a command signal output from an output device 14 and a feedback signal from the sensor 12, and controls the servo valve 11 such that the deviation becomes zero. As described above, the controller 13 performs a feedback control on the basis of the detection result from the sensor 12. The output device 14 is connected to the controller 13 in a wired or wireless manner, and the controller 13 is connected to the servo valve 11 in a wired or wireless manner.

The controller 13 may be provided for every servo valve 11, or a single controller 13 may control a plurality of servo valves 11. In addition, a single main controller may be provided, and sub-controllers each controlling the servo valve 11 in accordance with the command signal from the main controller may be provided for every servo valve 11. In a case in which the controller 13 is provided for every servo valve 11, the controller 13 may be modularized together with the first link 1, the second link 2, and the hydraulic cylinder 3 by providing the controller 13 so as to be connected to the servo valve 11 or the first link 1. In other words, the controller 13 may be configured as a component of the module 101.

The command signal that is output from the output device 14 is information defining the motion of the module 101. The command signal that is output from the output device 14 is the information directly input to the output device 14, the information transmitted to the output device 14 through a transmission circuit, the information read out from a storage medium, and so forth.

Next, configurations of the first link 1 and the second link 2 and coupling of the modules 101 will be described in detail with reference to FIGS. 1, and 3 to 5.

The first link 1 has a shape that is a rectangular parallelepiped with two faces among six faces are opened. The first link 1 has four faces, i.e. a bottom plate 1a that extends along the longitudinal direction of the hydraulic cylinder 3, a pair of side plates 1b and 1c that are formed so as to be perpendicular to the bottom plate 1a and to face with each other such that the hydraulic cylinder 3 is placed therebetween, and a back plate 1d that is perpendicular to the bottom plate 1a and the side plates 1b and 1c and faces a bottom portion of the hydraulic cylinder 3.

The shafts 4, 7, and 9 are provided on the pair of side plates 1b and 1c of the first link 1 so as to bridge over the both side plates 1b and 1c. A plurality of large-diameter holes 20 are formed in the bottom plate 1a and the pair of side plates 1b and 1c to reduce the weight.

The first link 1 has an interior space surrounded by the bottom plate 1a, the pair of side plates 1b and 1c, and the back plate 1d. Because a part of the hydraulic cylinder 3 is received in the interior space of the first link 1, the first link 1 also functions as a case of the hydraulic cylinder 3. The controller 13 may also be received in the interior space of the first link 1.

In the interior space of the first link 1, the face opposing the bottom plate 1a is opened. As the hydraulic cylinder 3 is extended/contracted, the hydraulic cylinder 3 moves into and out of the first link 1 through the open face. Specifically, as the hydraulic cylinder 3 is extended/contracted, the hydraulic cylinder 3 undergoes a swinging motion about the shaft 9 in the direction in which the hydraulic cylinder 3 is received in the first link 1 or in the direction in which the hydraulic cylinder 3 is exposed out from the first link 1.

A part of the pipes for connecting the first supply/discharge port 3c and the second supply/discharge port 3d of the hydraulic cylinder 3 with the servo valve 11 is accommodated in the interior space of the first link 1. The hydraulic cylinder 3 is attached to the first link 1 in the orientation in which the first supply/discharge port 3c and the second supply/discharge port 3d face the bottom plate 1a. Therefore, the pipes connected to the first supply/discharge port 3c and the second supply/discharge port 3d can easily be accommodated in the interior space of the first link 1. The pipes are routed to the outside from the inside of the interior space of the first link 1 through the holes 20. As described above, the holes 20 for the weight reduction formed in the first link 1 have the diameter larger than the pipes, and thereby, the holes 20 are also used for routing of the pipes.

The second link 2 has a bottom plate 2a, and a pair of side plates 2b and 2c that are formed so as to be perpendicular to the bottom plate 2a and to face with each other. The shafts 4 and 8 are provided on the pair of side plates 2b and 2c so as to bridge over the both side plates 2b and 2c.

Although the first link 1 and the second link 2 are made of metal, they may be made of a resin if a stiffness is not required for an application of the module 101.

End portions of the pair of side plates 2b and 2c of the second link 2 are inserted between end portions of the pair of side plates 1b and 1c of the first link 1 such that the pair of side plates 2b and 2c and the pair of side plates 1b and 1c can be rotated relatively about the shaft 4 in such a manner that they are brought into sliding contact with each other. In the above, the end portions of the pair of side plates 1b and 1c of the first link 1 may be inserted between the end portions of the pair of side plates 2b and 2c of the second link 2.

The bottom plate 1a, the side plates 1b and 1c, and the back plate 1d of the first link 1 are formed with a plurality of joint holes 21 into which joint tools for coupling the modules 101 are to be inserted. Similarly, the bottom plate 2a of the second link 2 is also formed with the plurality of joint holes 21 into which the joint tools for coupling the modules 101 are to be inserted. The plurality of joint holes 21 are formed at equal intervals from each other. The joint tool is, for example, a bolt. The joint holes 21 and the holes 20 for the weight reduction may have the same diameter such that holes are shared as the joint holes 21 and the holes 20. In the above, the plurality of joint holes 21 may not be formed at equal intervals from each other.

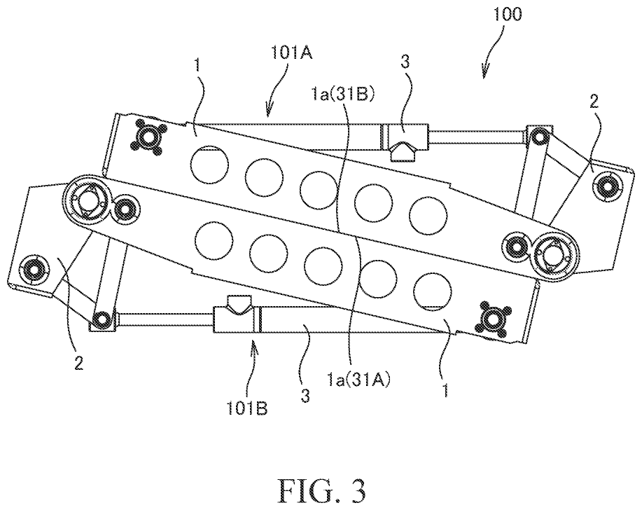

In a case in which two modules 101 are coupled with each other, as shown in FIGS. 3 to 5, any one of the bottom plate 1a, the side plates 1b and 1c, and the back plate 1d of the first link 1 and the bottom plate 2a of the second link 2 of a first module 101A is utilized as a coupling plate 31A, and at the same time, any one of the bottom plate 1a, the side plates 1b and 1c, and the back plate 1d of the first link 1 and the bottom plate 2a of the second link 2 of a second module 101B is utilized as a coupling plate 31B, and then, the joint tool is inserted so as to bridge over the joint holes 21 of the coupling plate 31A and the joint holes 21 of the coupling plate 31B in a state in which the coupling plate 31A and the coupling plate 31B are brought into surface contact with each other, thereby connecting the coupling plate 31A with the coupling plate 31B. In the above, because the plurality of joint holes 21 formed in the first link 1 and the second link 2 are formed at equal intervals from each other, it is possible to connect the coupling plate 31A and the coupling plate 31B with ease. As described above, the two modules 101A and 101B are coupled by connecting the first link 1 or the second link 2 of the module 101A with the first link 1 or the second link 2 of the module 101B.

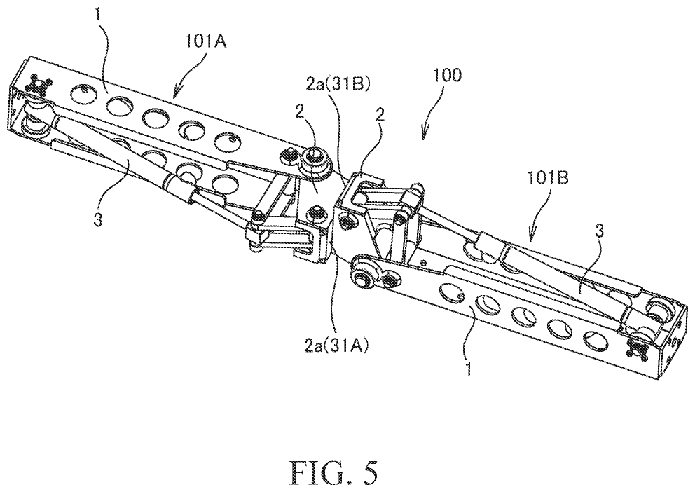

Coupling examples of the two modules 101A and 101B configuring the module robot 100 will be described with reference to FIGS. 3 to 5. In FIGS. 3 and 5, a case in which the module 101A and the module 101B that are identical to each other are coupled will be described. Here, in this description, “the identical modules” means that the components configuring the modules are identical to each other and that the shapes and dimensions of the components thereof are identical to each other. In other words, the identical modules can also be referred to as identically-standardized items.

FIG. 3 shows an example of a back plane coupling in which back planes of the module 101A and the module 101B are coupled with each other by setting both of the coupling plate 31A of the module 101A and the coupling plate 31B of the module 101B at the bottom plates 1a of the first links 1. Because the plurality of joint holes 21 are formed in the bottom plates 1a of the module 101A and the module 101B at equal intervals, it is also possible to couple the module 101A and the module 101B by changing relative positions of the module 101A and the module 101B from the state shown in FIG. 3.

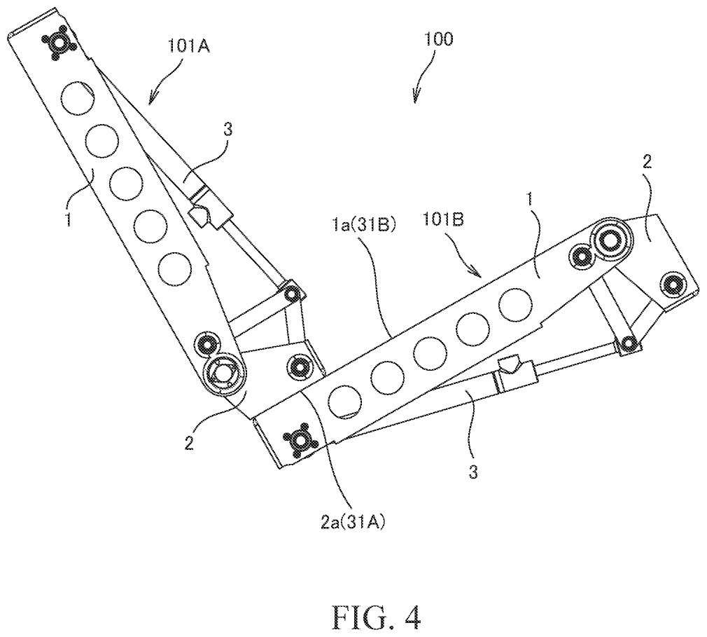

FIG. 4 shows an example of a series coupling in which the module 101A and the module 101B are coupled in series by setting the coupling plate 31A of the module 101A at the bottom plate 2a of the second link 2 and by setting the coupling plate 31B of the module 101B at the bottom plate 1a of the first link 1. As another example of the series coupling, the module 101A and the module 101B may be coupled by setting the coupling plate 31A of the module 101A at the bottom plate 2a of the second link 2 and by setting the coupling plate 31B of the module 101B at the back plate 1d of the first link 1. In addition, the module 101A and the module 101B may also be coupled by setting both of the coupling plate 31A of the module 101A and the coupling plate 31B of the module 101B at the back plates 1d of the first links 1.

FIG. 5 shows an example of a twisted coupling in which the module 101A and the module 101B are coupled by being rotated by 90 degrees by setting both of the coupling plate 31A of the module 101A and the coupling plate 31B of the module 101B at the bottom plates 2a of the second links 2.

In the examples shown in FIGS. 3 and 4, because the module 101A and the module 101B undergo the motion within the same plane, the module robot 100 undergoes, as a whole, a two dimensional motion. On the other hand, as shown in FIG. 5, by coupling the module 101A and the module 101B in the twisted coupling, the module robot 100 undergoes, as a whole, a three dimensional motion.

FIGS. 3 to 5 show the coupling examples of the modules 101A and 101B, and the module 101A and the module 101B are coupled freely in accordance with a desired motion of the module robot 100. For example, although FIGS. 3 to 5 show the examples in which the module 101A and the module 101B are coupled in series, it is also possible to couple the module 101A and the module 101B in parallel by connecting the side plate 1b of the first link 1 of the module 101A and the side plate 1c of the first link 1 of the module 101B. By controlling the respective hydraulic cylinders 3 in a synchronous manner after coupling the plurality of modules 101 in parallel, it is possible to increase the output power of the module robot. When the parallel coupling is employed, the shafts 4, 6, 7, 8, and 9 may be shared, and the plurality of hydraulic cylinders 3 may be controlled by a single servo valve 11 by sharing the servo valve 11.

When the first link 1 or the second link 2 of the module 101A and the first link 1 or the second link 2 of the module 101B are connected, it is possible to reduce the number of bolts to be used for connection by connecting the both links by utilizing an engagement structure. In addition, the both links may be connected by utilizing an electromagnet or a hydraulic clamp without using the bolts. In addition, pins may be provided on either one of the coupling plate 31A of the module 101A and the coupling plate 31B of the module 101B, and holes, into which the pins are inserted, may be formed in the other of the coupling plate 31A and the coupling plate 31B. Because it is possible to adjust the relative positions of the module 101A and the module 101B via the pins before coupling the module 101A and the module 101B by the bolts, the coupling work of the module 101A and the module 101B becomes easier.

Next, an example of the module robot 100 will be described with reference to FIG. 6. The module robot 100 shown in FIG. 6 shows the example in which a leg portion robot is configured by coupling three identical modules 101A, 101B, and 101C so as to correspond to an ankle joint, a knee joint, and a hip joint, respectively. Specifically, the rotation shafts 4 of the modules 101A, 101B, and 101C respectively correspond to the ankle joint, the knee joint, and the hip joint. As described above, each module 101 configures a single joint module, and the module robot 100 has three degrees of freedom.

The module 101A and the module 101B are coupled by the series coupling as shown in FIG. 4, and the module 101B and the module 101C are coupled by the back plane coupling as shown in FIG. 3. A foot member 31 as an attachment corresponding to a foot is attached to the second link 2 of the module 101A.

On the basis of the detection results from the encoders 12a respectively provided on the shafts 4, the respective controllers 13 of the modules 101A, 101B, and 101C respectively control the motions of the modules 101A, 101B, and 101C by extending/contracting the respective hydraulic cylinders 3 such that the relative rotational angles between the first links 1 and the second links 2 become desired angles. As the motion of each of the modules 101A, 101B, and 101C is independently controlled, a posture of the module robot 100 is controlled.

In addition, the respective controllers 13 of the modules 101A, 101B, and 101C respectively control torque for joints on the basis of the detection results from the pressure sensors 12b provided on the hydraulic cylinders 3. For example, the controllers 13 perform a gravity weight compensation control that controls the respective hydraulic cylinders 3 such that the own weight of the module robot 100 is cancelled out.

The module robot 100 is used as an autonomous walking robot or as a robot that assists the gait and the posture of a user by being worn by the user.

The module robot 100 is not limited to the leg portion robot shown in FIG. 6. The module robot 100 having other applications and functions may be formed by, for example, attaching a bucket or a rod as the attachment to the second link 2 of the module 101A instead of the foot member 31. In addition, it is possible to configure a humanoid robot by further coupling the plurality of modules 101 in addition to the leg portion robot shown in FIG. 6. As described above, it is possible to easily configure various robots in accordance with the applications and functions by only coupling the plurality of modules 101.

According to the above-described first embodiment, following operations and effects are obtained.

It is possible to easily configure the module robot 100 that can adapt to a wide variety of applications by coupling the plurality of modules 101 each having the first link 1, the second link 2, and the hydraulic cylinder 3. In addition, because the module robot 100 can be configured only by coupling the plurality of modules 101, it is easy to assemble the module robot 100, and when the module robot 100 is to be transported, it suffices to divide the module robot 100 into the respective modules 101. Therefore, the assembly and the transportation of the module robot 100 can be performed easily. Thus, it is possible to configure the module robot 100 that can adapt to a wide variety of applications and that can be assembled and transported with ease.

In addition, because a driving source of the module 101 is a hydraulic pressure, compared with a case in which the driving source is an electric motor, the output power of the module 101 relative to the module weight is high. Thus, even in a case in which the application of the module robot 100 requires a high output power, it is possible to prevent the increase in the size. In addition, because the extension/contraction of the hydraulic cylinder 3 is controlled by the servo valve 11, it is possible to control the motion of the module 101 with a high accuracy.

Modifications of the above-mentioned embodiment will be described below. The modifications described below also fall within the scope of the present invention. It may be possible to combine the following modifications with the respective configurations in the above-mentioned embodiment, and it may also be possible to combine the following modifications with each other.

(1) In the above-mentioned embodiment, a description has been given of the configuration in which the module 101 has single degree of freedom (a single joint). Instead of this configuration, the module may have a configuration with a plurality of degrees of freedom. When a plurality of degrees of freedom are to be achieved, it suffices to increase the number of the links or to change the hydraulic cylinder to a double-rod type.

(2) In the above-mentioned embodiment, a description has been given of the configuration in which the module 101 has the rotational degree of freedom. Instead of this configuration, the module may have a configuration with the translational degree of freedom. In this case, the hydraulic cylinder 3 is provided between the first member and the second member that are slidably linked in parallel with each other.

(3) In the above-mentioned embodiment, a description has been given of the configuration in which the identical modules 101 are coupled together. Instead of this configuration, the modules to be coupled may not be identical (may not be the same standard). For example, the modules having the first link and the second link with different shapes and/dimensions from each other may be coupled, or the modules having the hydraulic cylinder with different stroke length from each other may be coupled. In other words, the modules may be coupled freely in accordance with the desired motion of the module robot and the applications and functions of the module robot by preparing a plurality of modules with different standards. However, it is possible to manufacture the module robot with a lower cost by configuring the module robot by coupling the plurality of modules of the same standard.

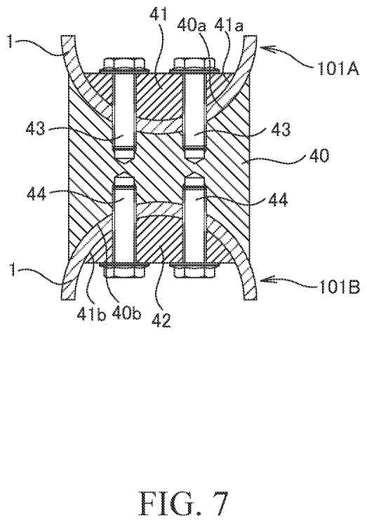

(4) In the above-mentioned embodiment, a description has been given of the configuration in which the first link 1 and the second link 2 of the module 101 have a plurality of plates, and as shown in FIGS. 3 to 5, the coupling plate 31A of the module 101A and the coupling plate 31B of the module 101B are connected with each other by being brought into surface contact. Instead of this configuration, as shown in FIG. 7, the first link 1 and the second link 2 of the module 101 may have a cylindrical shape a part there of is opened. FIG. 7 shows an example in which the module 101A and the module 101B are coupled by being arranged such that the back planes of the first links 1 face each other. In this configuration, in order to couple the module 101A and the module 101B, a spacer 40 is interposed between the first link 1 of the module 101A and the first link 1 of the module 101B, and spacers 41 and 42 are respectively provided inside the first links 1 of the module 101A and the module 101B. The spacer 40 has curved portions 40a and 40b that respectively come into contact with an outer circumferential surface of the first link 1 of the module 101A and an outer circumferential surface of the first link 1 of the module 101B. The spacer 41 has a curved portion 41a that comes into contact with an inner circumferential surface of the first link 1 of the module 101A, and the spacer 42 has a curved portion 41b that comes into contact with an inner circumferential surface of the first link 1 of the module 101B. Bolts 43 are fastened so as to bridge over the spacer 41, the first link 1 of the module 101A, and the spacer 40, and bolts 44 are fastened so as to bridge over the spacer 42, the first link 1 of the module 101B, and the spacer 40, and thereby, the module 101A and the module 101B are coupled. As described above, the shape of the first link 1 and the second link 2 may be the cylindrical shape. In addition, the shape of the first link 1 and the second link 2 may be a spherical shape or a shape formed by combining the cylindrical shape and the spherical shape.

(5) In the above-mentioned embodiment, a description has been given of the configuration in which the coupling plate 31A of the module 101A and the coupling plate 31B of the module 101B are connected by being brought into surface contact with each other. Instead of this configuration, a spacer may be interposed between the coupling plate 31A of the module 101A and the coupling plate 31B of the module 101B, and the module 101A and the module 101B may be coupled via the spacer. By interposing the spacer, it is possible to form a gap between the module 101A and the module 101B.

(6) In the above-mentioned embodiment, a description has been given of the configuration in which the module 101A and the module 101B are coupled such that a relative movement thereof is not allowed. Instead of this configuration, the module 101A and the module 101B may be coupled such that the relative movement is allowed. For example, the module 101A and the module 101B may be coupled via a pin so as to be rotatable or swingable with each other or so as to be rotatable and swingable with each other about the pin. In such a case, it may be possible to provide a motive-power source for mutually rotating and/or swinging the module 101A and the module 101B.

(7) In the above-mentioned embodiment, a description has been given of the configuration in which the module 101 has the V-shaped link 5 that freely rotatably links the first link 1 and the second link 2. The V-shaped link 5 is not an essential component in the present invention. The hydraulic cylinder 3 may be provided so as to be linked over the first link 1 and the second link 2 directly. However, in the above-mentioned embodiment in which the first link 1 and the second link 2 are linked by the V-shaped link 5, the rotation shaft 4 of the first link 1 and the second link 2 is positioned between the rotation shafts 7 and 8 of the V-shaped link 5 and the angle of the V-shaped link 5 is changed along with the relative rotation of the first link 1 and the second link 2, and therefore, it is possible to make the stroke length of the hydraulic cylinder 3 shorter, and in turn, it is possible to make the hydraulic cylinder 3 compact.

(8) In the above-mentioned embodiment, a description has been given of the configuration in which the control valve for controlling the supply and discharge of the working oil between the pump 10 and the hydraulic cylinder 3 is the servo valve 11. The control valve is not limited to the servo valve 11, and it may be the control valve of a solenoid controlled pilot operated type, etc. In addition, the supply and discharge of the working oil to and from the hydraulic cylinder 3 by the pump 10 may be controlled without providing the control valve (the servo valve 11). In this case, a rotation speed of the pump or a capacity of the pump may be controlled.

(9) In the above-mentioned embodiment, the first supply/discharge port 3c that is in communication with the rod side chamber of the hydraulic cylinder 3 is provided on the outer circumference of the cylinder tube 3a as shown in FIG. 1. Instead of this configuration, the first supply/discharge port 3c may be configured so as to communicate with the oil passage formed in the rotation shaft 9 by providing the first supply/discharge port 3c on a bottom portion of the cylinder tube 3a. By employing such a configuration, because it suffices to connect an opening portion of the oil passage formed on an end surface of the rotation shaft 9 with the servo valve 11 by a pipe, the pipe can be routed with ease. In such a case, by using the three-dimensional printer for molding of the cylinder tube 3a, it is possible to easily form the first supply/discharge port 3c on the bottom portion of the cylinder tube 3a.

(10) In the above-mentioned embodiment, a description has been given of the configuration in which the fluid pressure cylinder is the hydraulic cylinder 3 using the working oil as the working fluid; however, instead of using the working oil, other fluids such as working water, etc. may also be used as the working fluid.

### Second Embodiment

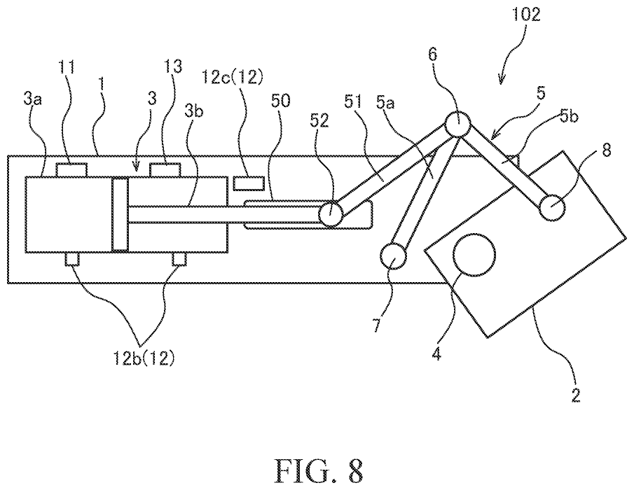

Next, a second embodiment of the present invention will be described with reference to FIG. 8. FIG. 8 is a schematic view of a module 102 according to the second embodiment of the present invention. In the following, the differences with respect to the above-described first embodiment will be described, and the configurations having the same functions as those in the above-described first embodiment are assigned the same reference numerals in the drawings, and a description thereof will be omitted.

In the module 101 according to the above-described first embodiment, one of the end portions of the hydraulic cylinder 3 is rotatably linked to the first link 1. In contrast, in the module 102 according to the second embodiment, the hydraulic cylinder 3 is built into the first link 1 and linked to the first link 1 so as not to be rotatable. A detailed described will be given below.

In the module 102, the cylinder tube 3a is linked to the first link 1 so as not to be rotatable. In other words, the cylinder tube 3a is fixed to the first link 1 so as not to move relative to the first link 1.

The end portion of the piston rod 3b is linked to the V-shaped link 5 serving as the third link via a crank 51. The crank 51 is rotatably linked to the end portion of the piston rod 3b at its first end portion via a shaft 52, and a second end portion of the crank 51 is rotatably linked to the shaft 6 of the V-shaped link 5. The first link 1 is provided with a linear guide 50 so as to extend in the axial direction of the piston rod 3b, and the piston rod 3b is moved along the linear guide 50.

As the hydraulic cylinder 3 is extended/contracted, the angle formed between the piston rod 3b and the crank 51 and the angle of the V-shaped link 5 are changed, and the first link 1 and the second link 2 are rotated about the shaft 4 relatively with each other. As described above, by driving the hydraulic cylinder 3, it is possible to relatively rotate the first link 1 and the second link 2 with each other.

By adjusting the length of the crank 51, the rotation torque of the first link 1 and the second link 2 can be adjusted.

In the module 101 according to the above-described first embodiment, the hydraulic cylinder 3 moves into and out of the first link 1 as the hydraulic cylinder 3 is extended/contracted. In contrast, in the module 102, because the hydraulic cylinder 3 is linked by being built into the first link 1 so as not to be rotatable, the hydraulic cylinder 3 does not move into and out of the first link 1 as the hydraulic cylinder 3 is extended/contracted. Thus, it is possible to configure the module 102 so as to be compact.

The module 102 includes: the servo valve 11 serving as the control valve that controls the supply and discharge of the working oil between the pump 10 and the hydraulic cylinder 3; the sensor 12 serving as the state-quantity detector that detects the state quantity of the module 101; and the controller 13 that controls the motion of the module 102 by controlling the operation of the servo valve 11 on the basis of the detection result from the sensor 12. The servo valve 11, the sensor 12, and the controller 13 are each configured as a component of the module 102.

The servo valve 11 is provided on each module 102 and independently controls the hydraulic cylinder 3. In this embodiment, the module 102 has, as the sensor 12: the pressure sensors 12b that detect the pressure of the hydraulic cylinder 3 (the pressure in the rod side chamber and the counter rod side chamber in the cylinder tube 3a) as the state quantity of the module 101; and a linear encoder 12c that detects a displacement of the piston rod 3b.

In the module 102, because the cylinder tube 3a is fixed to the first link 1 so as not to move relatively, the servo valve 11, the pressure sensors 12b, the linear encoder 12c, and the controller 13 can be built into the first link 1. Thus, it is possible to configure the module 102 so as to be compact and to prevent these components from being damaged.

In the above, the crank 51 and the V-shaped link 5 are not essential components in the present invention. The crank 51 may be rotatably linked to the second link 2 by omitting the V-shaped link 5, or the end portion of the piston rod 3b may be rotatably linked to the second link 2 by omitting the crank 51 and the V-shaped link 5.

The configurations, operations, and effects of the embodiments of the present invention will be collectively described below.

The module robot 100 is configured by coupling the plurality of modules 101 each having: the first link 1 (the first member); the second link 2 (the second member) that is movably linked to the first link 1 relatively; and the hydraulic cylinder 3 (the fluid pressure cylinder) that moves the first link 1 and the second link 2 relatively.

With this configuration, it is possible to configure the module robot 100 that can adapt to a wide variety of applications by coupling the plurality of modules 101 each having the first link 1, the second link 2, and the hydraulic cylinder 3. In addition, because the module robot 100 can be configured only by coupling the plurality of modules 101, it is easy to assemble the module robot 100, and when the module robot 100 is to be transported, it suffices to divide the module robot 100 into the respective modules 101. Therefore, the assembly and the transportation of the module robot 100 can be performed easily. Thus, it is possible to configure the module robot 100 that can adapt to a wide variety of applications and that can be assembled and transported with ease.

In addition, the module robot 100 is configured by coupling at least two identical modules 101.

With this configuration, it is possible to manufacture the module robot 100 at a low cost.

In addition, the first member and the second member are the first link 1 and the second link 2, respectively, the first link 1 and the second link 2 being rotatably linked.

In addition, the hydraulic cylinder 3 is linked to the first link 1 so as not to be rotatable.

With this configuration, it is possible to configure the module 102 so as to be compact.

In addition, the module 101, 102 further has the V-shaped link 5 (the third link), the V-shaped link 5 being configured to freely rotatably link the first link 1 and the second link 2, and the hydraulic cylinder 3 is linked to the first link 1 at the first end portion thereof and linked to the V-shaped link 5 at the second end portion thereof.

With this configuration, it is possible to make the stroke length of the hydraulic cylinder 3 shorter and to make the hydraulic cylinder 3 compact.

In addition, the module robot 100 further includes: the pump 10 (the working fluid source) configured to supply the working fluid to the hydraulic cylinder 3; and the servo valve 11 (the control valve) configured to control the supply and discharge of the working oil (the working fluid) between the pump 10 and the hydraulic cylinder 3.

In addition, the module 101, 102 further has: the sensor 12 (the state-quantity detector) configured to detect the state quantity of the module 101; and the controller 13 configured to control the motion of the module 101 by controlling the operation of the servo valve 11 based on the detection result from the sensor 12.

With these configurations, it is possible to control the motion of the module robot 100.

In addition, the two modules 101A and 101B are coupled by connecting the first link 1 or the second link 2 of the first module 101A with the first link 1 or the second link 2 of the second module 101B, and the first link 1 and the second link 2 respectively have the coupling plates 31A and 31B, the coupling plates 31A and 31B being configured to be connected by being brought into surface contact with each other.

In addition, the coupling plates 31A and 31B are each formed with the plurality of joint holes 21 at equal intervals from each other, the joint holes 21 being configured such that the joint means are respectively inserted into the joint holes 21, the joint means being configured to couple the coupling plates 31A and 31B.

With these configurations, it is possible to connect the coupling plate 31A of the first module 101A with the coupling plate 31B of the second module 101B with ease.

In addition, the hydraulic cylinder 3 is built into the first link 1.

In addition, the module 102 further has: the servo valve 11 (the control valve) configured to control the supply and discharge of the working fluid between the pump 10 (the working fluid source) and the hydraulic cylinder 3; the sensor 12 (the state-quantity detector) configured to detect the state quantity of the module 102; and the controller 13 configured to control the motion of the module 102 by controlling the operation of the servo valve 11 based on the detection result from the sensor 12, and the servo valve 11, the sensor 12, and the controller 13 are built into the first link 1.

With these configurations, it is possible to configure the module 102 so as to be compact.

In addition, in the module robot 100, a leg portion is configured by coupling the three modules 101A, 101B, and 101C so as to correspond to the ankle joint, the knee joint, and the hip joint.

With this configuration, it is possible to configure the leg portion robot only by coupling the three modules 101A, 101B, and 101C.

Embodiments of this invention were described above, but the above embodiments are merely examples of applications of this invention, and the technical scope of this invention is not limited to the specific constitutions of the above embodiments.

This application claims priority based on Japanese Patent Application No. 2019-119950 filed with the Japan Patent Office on Jun. 27, 2019, the entire contents of which are incorporated into this specification.

1. A module robot, comprising a plurality of modules, the modules being coupled together, each module having a first link, a second link rotatably linked to the first link, and a fluid pressure cylinder configured to rotate the first link and the second link relative to each other, wherein the fluid pressure cylinder is linked to the first link so as not to be rotatable.

2. The module robot according to claim 1, wherein
the module robot is configured by coupling the identical at least two modules.

3. (canceled)

4. (canceled)

5. The module robot according to claim 1, wherein
the module further has a third link, the third link being configured to freely rotatably link the first link and the second link, and
the fluid pressure cylinder is linked to the first link at a first end portion thereof and is linked to the third link at a second end portion thereof.

6. The module robot according to claim 1, further comprising:
a working fluid source configured to supply working fluid to the fluid pressure cylinder; and
a control valve configured to control supply and discharge of the working fluid between the working fluid source and the fluid pressure cylinder.

7. The module robot according to claim 6, wherein
the module further has:
a state-quantity detector configured to detect a state quantity of the module; and
a controller configured to control motion of the module by controlling operation of the control valve on the basis of detection result from the state-quantity detector.

8. The module robot according to claim 1, wherein
the two modules are coupled by connecting the first link or the second link of one of the modules with the first link or the second link of other of the modules, and
the first link and the second link respectively have coupling plates, the coupling plates being configured to be connected by being brought into surface contact with each other.

9. The module robot according to claim 8, wherein
the coupling plates are each formed with a plurality of joint holes at equal intervals from each other, the joint holes being configured such that joint tools are respectively inserted into the joint holes, the joint tools being configured to couple the coupling plates.

10. The module robot according to claim 1, wherein
the fluid pressure cylinder is built into the first link.

11. The module robot according to claim 10, wherein
the module further has:
a control valve configured to control supply and discharge of working fluid between a working fluid source and the fluid pressure cylinder;
a state-quantity detector configured to detect a state quantity of the module; and
a controller configured to control motion of the module by controlling operation of the control valve on the basis of detection result from the state-quantity detector, and
the control valve, the state-quantity detector, and the controller are built into the first link.

12. The module robot according to claim 1, wherein
a leg portion is configured by coupling the three modules so as to correspond to an ankle joint, a knee joint, and a hip joint.
